(19) United States
(12) Patent Application Publication
(10) Pub. No.: US 2010/0089599 A1
(43) Pub. Date: Apr. 15, 2010

(54) SPRAYING HEAD, FIRE-EXTINGUISHING APPARATUS AND METHOD

(76) Inventors: Göran Sundholm, Tuusula (FI); Harry Metzger, Kerava (FI); Jyrki Hyytiäinen, Kerava (FI)

Correspondence Address: LADAS & PARRY LLP, 26 WEST 61ST STREET, NEW YORK, NY, 10023, US

(21) Appl. No.: 12/520,564

(22) PCT Filed: Feb. 19, 2008
(86) PCT No.: PCT/FI08/50070

§ 371 Date: Jun. 22, 2009

(30) Foreign Application Priority Data
Feb. 19, 2007 (FI) 20070142

(51) Int. Cl. A62C 2/00

(52) U.S. Cl. 169/46; 169/5

(57) ABSTRACT

A spraying head, which comprises a body (2) and several spray nozzles (7), the type of which spray nozzles is such that they, when activated, provide suction in their vicinity. The body (2) of the spraying head is formed frame-like, whereby through the body from a first side to a second side leads a channel (14), and that the spray nozzles (7) are arranged or formed in the body or into connection with it so that, when the spray nozzles are activated, suction is formed from the first side of the body into the channel (14).

### BACKGROUND OF INVENTION

The invention relates to a spraying head according to the preamble of claim 1.

The invention also relates to an apparatus according to claim 16 and a method according to claim 17.

Different arrangements are known for extinguishing, controlling or damping a fire with liquid mist. For simplicity, these will be solely referred to with the term fire extinguishing. An extremely well operating arrangement is described in FI patent 100947 (WO 92/20453). In the embodiment of the specification in question, sprays coming from several different nozzles of a spraying head are combined “together” by means of a combination of certain parameters providing a desired mainly single flow pattern which increases, inter alia, the penetration of the mist spray of the spraying head, whereby in fire extinguishing is provided an effective arrangement required when extinguishing certain fires. Another typical characteristic of fire extinguishing with liquid mist, particularly when using quite high pressures, is suction provided by the sprays in the immediate surroundings. This suction draws flue gases into the spray, which on one hand cools the hot flue gases but also utilises them in fire extinguishing, because they displace oxygen thus aiding in extinguishing the fire.

The object of this invention is to provide an arrangement by means of which the characteristics of the liquid mist spraying head, inter alia, the suction provided and the penetration of mist sprays, can be further made more effective.

### BRIEF DESCRIPTION OF INVENTION

The spraying head according to the invention is mainly characterised in that the body of the spraying head is formed frame-like, whereby through the body from a first side to a second side leads a channel, and that spray nozzles are arranged or formed in the body or into connection with it so that when the spray nozzles are activated suction is formed from the first side of the body into the channel.

The spraying head according to the invention is further characterised by what is stated in claims 2-15.

The fire-extinguishing apparatus according to the invention is mainly characterised by what is stated in claim 16.

The method according to the invention is characterised by what is stated in claim 17.

The arrangement according to the invention has numerous significant advantages. By arranging a frame-like body to the spraying head through which body leads a channel and spray nozzles arranged in a certain way into connection with the body, on one hand, extremely effective and directed suction of flue gases is provided in the spray through the channel. At the same time is also effectively provided a combined mainly uniform mist spray having good penetration. By directing the nozzles, it is also possible to affect the drop size of the spray, the sprays of different nozzles colliding, at least partly, with each other. By directing the nozzles, it is also possible to affect the behaviour of the mist, whereby it is possible e.g. to provide a rotational motion of the combined mist spray. By arranging a pipe element as an extension of the channel going through the body part, suction can be further intensified particularly through the channel and also the mist spray provided by the spraying head can be directed. By means of the spraying head according to the invention, it is also possible to achieve satisfactory results with low operating pressures at targets which require the above-described quite uniform mist spray having good penetration and an effective gas recirculation caused by suction through the mist sprays.

### BRIEF DESCRIPTION OF FIGURES

Next, the invention will be described in detail by means of an example with reference to the accompanying drawing in which

FIG. 1 shows an apparatus according to the invention,

FIG. 2 shows a cross-section of a spraying head according to the invention at a different scale along line II-II of FIG. 3,

FIG. 3 shows a top view of an embodiment of the spraying head to according to the invention,

FIG. 4 shows a side view of an embodiment of the spraying head according to the invention,

FIG. 5 shows an oblique bottom view of an embodiment of the spraying head according to the invention,

FIG. 6 shows an oblique top view of an embodiment of the spraying head according to the invention,

FIG. 7 shows a cross-section of a second embodiment of the spraying head according to the invention,

FIG. 8 shows a top view of a third embodiment of the spraying head according to the invention.

### DETAILED DESCRIPTION OF INVENTION

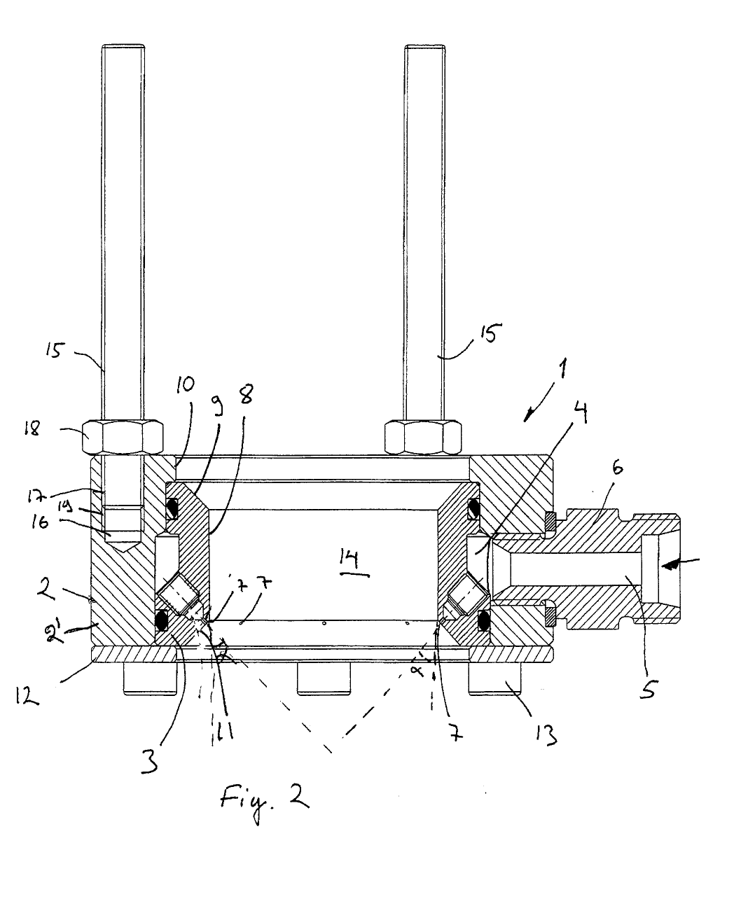

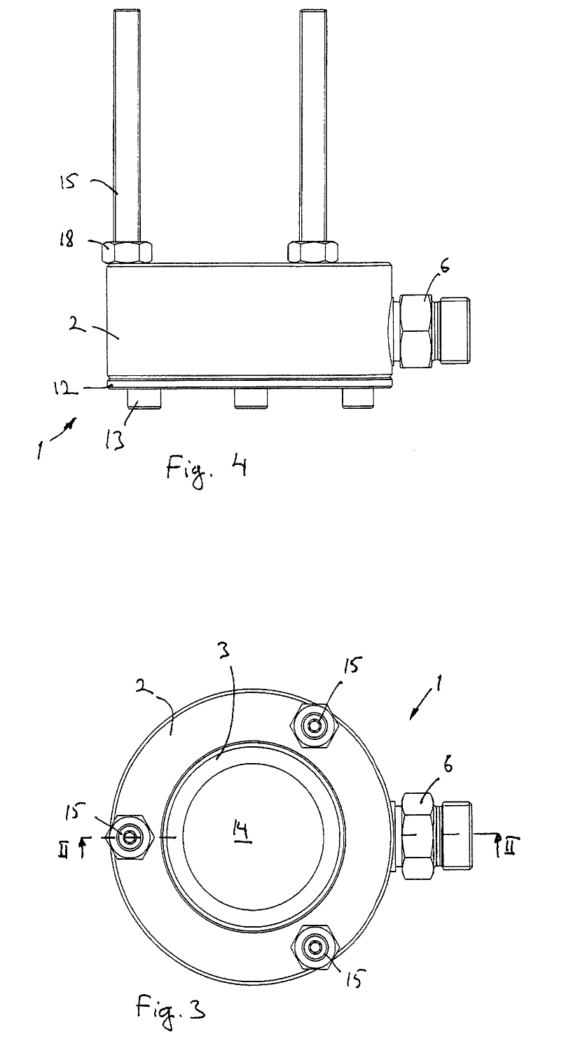

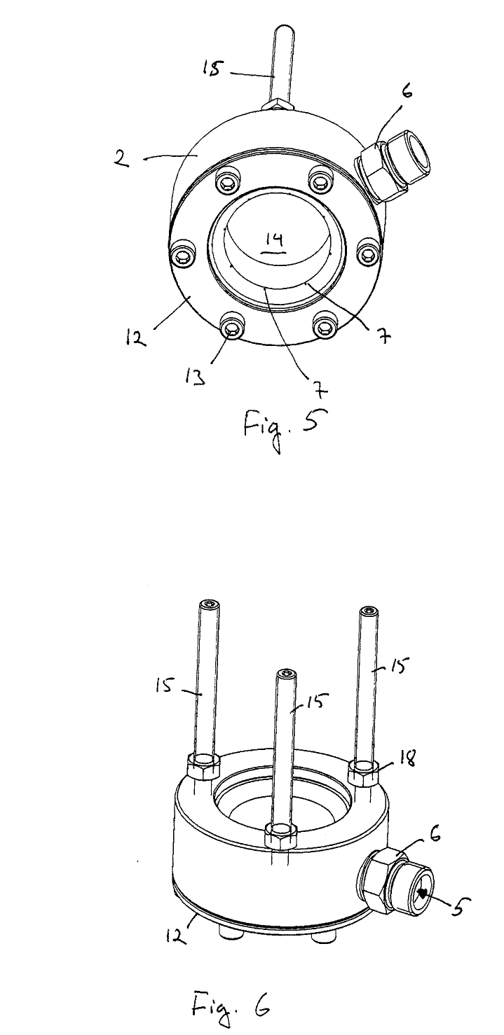

FIGS. 2-6 show an embodiment of a spraying head 1 according to the invention comprising a frame-like body 2, from a first side of which, from the top in the figure, to a second side leads a channel 14. In the embodiment of the figures, the body 2 surrounds the channel 14. In the figure, the frame-like body 2 is formed annular of its shape. The shape of the frame-like body can be any other shape, e.g. rectangular, elliptical, polygonal etc., as long as there is a channel 14. In the frame-like body 2 or into connection with it are formed or arranged nozzles 7. The nozzles 7 are directed so that, when activated, they provide suction due to spraying, at least in the vicinity of the inlet of the channel 14, from outside the spraying head towards the channel 14. Several nozzles 7, at least two, are arranged dividedly on the inner circle of the body 2. In the embodiment of the figure, the outlet opening of the nozzle 7 opens on a surface 8 on the side of the channel 14 of the body 2. On the wall 8 on the side of the channel 14 of the body, bevels 9, 11 are formed in the embodiment of the figure. On the inlet side of the channel, there is a narrowing surface of the shape of a truncated cone, whereby the channel contracts into the shape of a cylinder and again expands on the outlet side in the area of a surface 11 of the shape of a truncated cone. In FIG. 2, the nozzles are arranged at the end on the outlet side of the channel 14 of the body. The nozzles 7 are, in the embodiment of FIG. 2, directed to spray obliquely in the centre downwards. In the embodiment of FIG. 2, the spray directions of the nozzles intersect at a distance on the other side of the body i.e. on the outlet side of the channel 14. In the figure, the outlet opening of the nozzles 7 is on the bevelled surface 11. The bevelled surface 11 forms an expanding conical surface for the channel 14. The nozzles are advantageously inclined at an angle α (alpha) with respect to an axis in the direction of the main run direction of the channel 14 of the spraying head. In the figure, the spray direction of the nozzles on opposite sides of the channel is thus inclined each for the angle α towards each other. According to an embodiment, the angle alpha can vary e.g. between 0-89 degrees, typically between 10-80 degrees, advantageously between 30-75 degrees.

The type of the nozzles 7 is such that they provide suction in the channel 14 of the frame-like body, from the inlet opening of its first side towards the outlet opening on the second side of the body.

The sprays of the nozzles 7 are, according to an advantageous embodiment, arranged to spray in the figure obliquely downwards towards each other, whereby the sprays on one hand collide with each other and advantageously are combined into an at least mainly uniform mist spray.

In the embodiment of the figures, the frame-like body 2 of the spraying head is formed of an outer body 2′ and an inner body 3 between which there is a channel space 4. In the body is arranged at least one inlet 5 which is in a medium connection with the channel space 4. From the channel space 4, there further exists a medium connection to the nozzles 7. In the case of the figure, the channel space 4 is an annular space. The nozzles 7 are arranged dividedly on the wall surrounding the channel of the body when activated to provide a mist spray towards the outlet opening of the channel 14. The nozzles are advantageously arranged at an angle α (alpha) with respect to an axis in the direction of the channel 14. The nozzles are arranged when activated to spray aqueous medium mist, particularly extinguishing medium mist, or a mixture of aqueous medium mist, such as extinguishing medium mist, and gas. The mist sprays of different nozzles 7 are arranged in the embodiment of the figure to collide with each other at least partly. Due to the collision, at least part of the drops of the medium being sprayed diffuse into smaller drops. The sprays provided by different nozzles 7 are combined at least partly into a larger spray. At the same time, the sprays cause powerful suction on the side of the inlet opening of the channel 14. The spraying head 1 is advantageously fastened at a distance from an installation surface so that a sufficient distance remains between the inlet opening of the channel and the installation surface, such as a ceiling. Then, the gases, such as flue gases, rising to the upper part of the space in a fire situation are effectively controlled into the coverage area of the suction provided by the sprays of the activated spraying head 1. By arranging the frame-like body 2 according to the invention into the spraying head and therein the channel 14, the inlet opening i.e. suction opening being directed on the side of the fastening surface, extremely efficient suction of flue gases is provided into connection with the mist sprays.

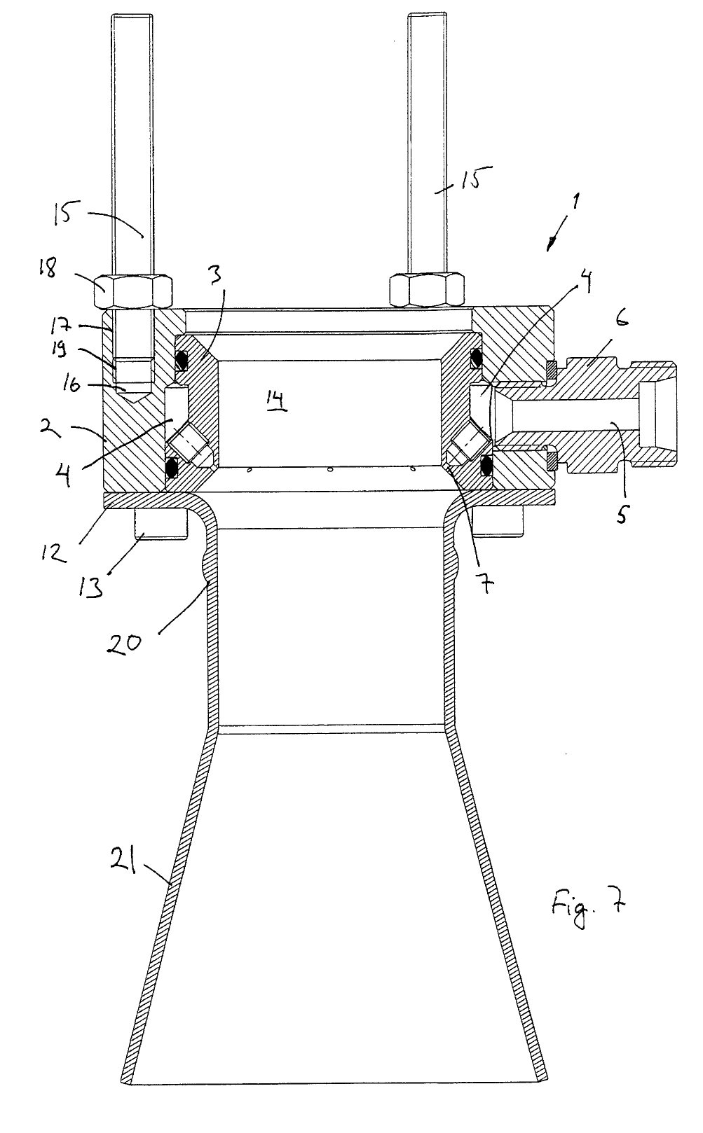

Suction can be further intensified by arranging into connection with the spraying head a pipe part 20 according to FIG. 7 into connection with the outlet opening of the channel 14. The pipe part 20, on one hand, prevents the access of gases surrounding the spraying head 1 into the spray from the side of the outlet opening of the channel 14, whereby the suction effect on the side of the inlet opening of the channel is intensified. Then in a fire situation, inter alia, flue gases are effectively guided into connection with the mist spray particularly through the inlet opening of the channel 14. As known, the flue gases include gases, such as e.g. CO and CO₂, which when sprayed in the seat of fire in connection with the mist, inter alia, displace oxygen and thus contribute for their part to the extinction of the fire. By means of the spraying head according to the invention, flue gases can be very effectively guided into connection with the mist sprays and further towards the fire site.

Furthermore, the mist sprays effectively cool the gases absorbed among them, whereby by the spraying head according to the invention it is possible to, inter alia, cool the fire space extremely efficiently.

Correspondingly, the pipe part 20 further intensifies the combination of the mist sprays and directs them effectively. In addition, sprays and gases coming from the effect of suction through the channel 14 are able to mix effectively in the interior space of the pipe part operating as the extension of the channel space.

In the pipe part 20, there is, in the embodiment according to FIG. 7, a horn-like section 21 on the outlet end of the pipe part. In the figure, the horn-like section 21 is of the shape of a truncated cone, whereby it expands towards the outlet end.

In the embodiment of the figures, in the outer body 2′ of the spraying head there is a shoulder 10 against which the inner body 3 is set. The outer body 2′ and the inner body 3 are fastened to each other by a flange 12 and fastening means 13. In the inner body are formed grooves in which are arranged sealing elements, such as ring seals, e.g. O rings. The sealing means are thus arranged in the connection point of the inner body 3 and the outer body on opposite sides of the channel space 4.

In the embodiment of FIG. 7, the flange 12 and the pipe element 20 are combined, whereby the flange part 12 is formed in the pipe element 20 by which it is fast in the body 2, which flange part 12 at the same time keeps the inner body 3 in place in a way described above.

The spraying head 1 can be coupled by a pipeline to a pressure medium source which can comprise e.g. at least one tank for the extinguishing medium and a pressure gas source. It is also possible to use a pump device to pump extinguishing medium into the pipeline. Also a combination of a pressure gas source, an extinguishing medium source and a pump device is possible. The extinguishing medium is brought from the inlet 5 of the body from which it runs to the channel space 4 and further to the nozzles 7 and from their outlet opening as a desired kind of mist spray into the channel 14 or in its vicinity. The inlet is arranged by means of a coupler 6 into the body 2.

In the spraying head, bores 16 are formed on its first side in the outer body 2′ in which are formed threads 19 in which are further fastenable fastening elements 15 of the spraying head, such as threaded bars. The fastening elements are quite long in order for a sufficient space to remain between the spraying head and the installation surface, such as a ceiling, from which space, when the spraying head activates, gases, such as flue gases, are sucked. The fastening elements 15 are tightened with nuts 18 in place in the body.

The apparatus can comprise at least one fire, smoke and/or heat detector 30.

The nozzles of the spraying head are, when activated, arranged to spray aqueous extinguishing medium mist in the channel 14 or in its vicinity. Gases, such as flue gases, run in the channel 14 into the mist spray of the nozzles 7 and further along with the sprays.

According to a further embodiment shown in FIG. 8, at least part of sprays 7′ of the nozzles 7 are arranged to provide a rotational motion for the mist. According to an advantageous embodiment, at least part of the sprays of the nozzles 7 are directed so that a rotational motion is provided for the mist. Typically, at least part of the sprays of the nozzles are directed to provide a rotational motion for the mist in the channel 14 and/or in the pipe element 20 being its extension. When the combined mist spray proceeds in the channel 14 and/or the pipe element 20 towards its outlet opening, it simultaneously rotates around an axis in the direction of the run direction. FIG. 8 illustrates this with curved arrows in the channel 14. In the figure, arrows 7′ show the main spray direction of the nozzles. In the figure, the spray direction 7′ is directed deviating for an angle β (beta) with respect to the normal of the surface of the channel 14. In the case of FIG. 8 in which the cross-section of the channel 14 is a circle, the spray direction 7′ deviates from the direction of the radius for the angle β in the direction of the desired rotation direction of the mist.

It is also possible to arrange nozzles 7 having different characteristics into connection with the spraying head, whereby the combined mist can be affected. Then, it is possible, inter alia, to affect the behaviour of the mist, such as the rotational motion, without particularly directing the sprays of different nozzles. Also the irregular locating of the nozzles can affect the behaviour of the mist.

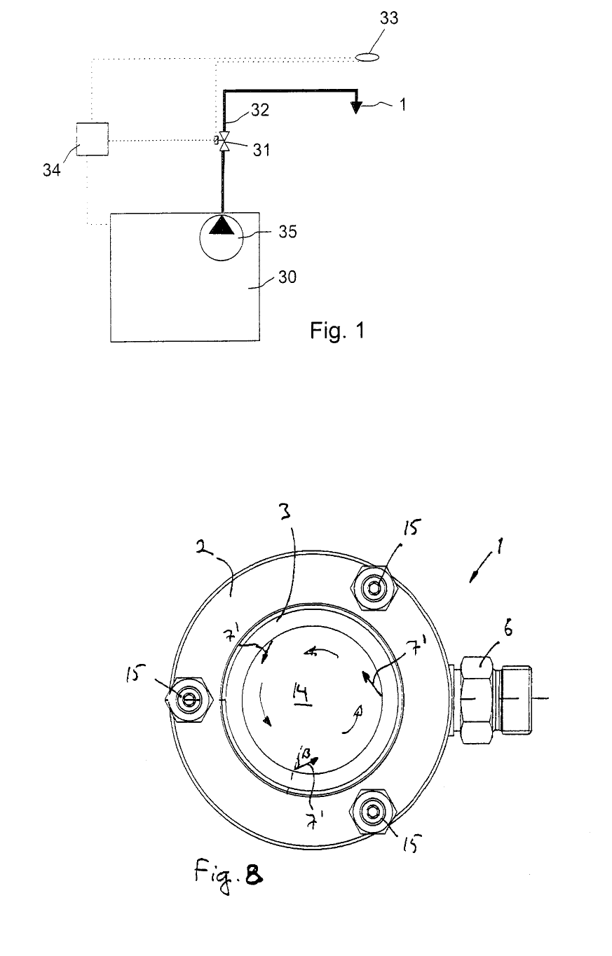

FIG. 1 shows a simplified arrangement for delivering extinguishing medium to the spraying head. There, an extinguishing medium source is designated with reference number 30. From the extinguishing medium source leads a pipeline 32 to at least one spraying head 1. Between the extinguishing medium source and the spraying head is arranged at least one valve element 31 for opening and closing the passage of extinguishing medium to the spraying head. The extinguishing medium source can be e.g. a pressure tank or a combination of a tank and a pump means, whereby a pump means 35 pumps extinguishing medium into the pipeline 32. The pump means can be e.g. a constant pressure pump. The pressure in the piping can typically be over 30 bar, advantageously over 50 bar, most advantageously over 70 bar. The used pressure can also be, depending on the target of application, lower than the above-mentioned, e.g. below 12 bar. The system typically comprises a heat, fire or smoke detector 33 which gives an impulse which opens a connection, by opening the valve 31, from the extinguishing medium source 30 to the spraying head 1, either directly or controlled by a control system 34.

Alternatively, the arrangement can comprise at least one liquid tank and at least one gas tank. The gas of the gas tank is used as a pressure source to drive the extinguishing medium from the tank to the spraying head 1. The gas can also be mixed with water mist, inter alia, for diminishing the drop size. The apparatus is triggered e.g. as a result of a control command coming from the fire detector 33. Then, the valve of the operating source opens and feeds gas via the pipeline into the liquid tank. Then, liquid or a mixture of liquid and gas is fed under pressure along the pipeline to the nozzle 7 of the spraying head 1. From the nozzles of the spraying head 1, aqueous extinguishing medium mist sprays under pressure into the channel or its vicinity. At the same time, as a result of spraying is created powerful suction on the side of the inlet of the channel 14 which provides the run of smoke and flue gases into the channel 14 through its inlet.

The dimensions of the channel 14 are dependent on the embodiment. In some embodiments, the cross-section of the channel being circular, its diameter d can be of the range of 50-150 mm but, depending on the target of application, it can also be smaller or larger than the described dimensions. The length I of the pipe part 20 is also dependent on the target of application. It can be considered that in some cases the length of the pipe part I=1 . . . 5*d, in which d is the effective diameter of the channel. In the embodiment of FIG. 7, the length of the pipe part is about I=3d. The length, shape and dimensions of the pipe part can vary according to the requirements of each target of application.

The nozzles 7 can be e.g. nozzles formed by boring directly in the body 2 or alternatively e.g. separate nozzle bodies known as such attached to the borings. It is substantial that with the nozzles is provided a mist spray which also provides suction in its vicinity.

The arrangement according to the invention can also be utilised in other targets of application than in connection with fire extinguishing, e.g. in connection with explosive spaces. Then, explosive particles and/or gases run in the coverage area of the suction of the nozzle heads into connection with the mist sprays of the nozzle heads and possible explosion threat can be diminished considerably. The use of the spraying head is also suitable for removing water-soluble gases from the space, whereby gases guided in the mist spray, inter alia, from the effect of suction dissolve into mist drops which can be collected and conveyed when required out of the space.

The spray nozzle according to the invention is intended for spraying medium mist. The used pressures can typically be over 1 bar and below 300 bar. With the spraying head, it is possible to provide even with relatively low pressures, e.g. pressures being below 12 bar, depending on the embodiment, mist and a desired suction effect in a satisfactory way. Conventionally, the nozzle can be used with pressures which are 12-30 bar and/or with high pressures which are over 30 bar.

In typical cases in connection with the spraying head according to the invention, the principle applies that the higher the pressure, the higher motion speed is achieved and, as its result, also greater suction.

The characteristics of the liquid mist provided with the nozzles vary according to the target of application. The drop size (Dᵥ₉₀) of mist being sprayed is typically below 1,000 micrometres, advantageously below 600 micrometres, most advantageously below 400 micrometres.

It is obvious to those skilled in the art that the invention is not limited to the embodiments described above, but it may be varied within the scope of the enclosed claims. Part of the characteristic features of the invention are presented in the description together with other characteristic features, even though they can also be applied separate from each other.

1. A spraying head, which comprises a body (2) and at least two spray nozzles (7), the type of which spray nozzles is such that they, when activated, provide suction in their vicinity, characterised in that the body (2) of the spraying head is formed frame-like, whereby through the body from a first side to a second side leads a channel (14), and that the spray nozzles (7) are arranged or formed in the body or into connection with it so that, when the spray nozzles are activated, suction is formed from the first side of the body into the channel (14).

2. A spraying head according to claim 1, characterised in that the spray direction of the spray nozzle (7) is arranged at an angle ? (alpha) with respect to an axis in the direction of the channel (14).

3. A spraying head according to claim 1, characterised in that the nozzles (7) are when activated arranged to spray aqueous medium mist, particularly extinguishing medium mist, or a mixture of aqueous medium mist, such as extinguishing medium mist, and gas.

4. A spraying head according to claim 1, characterised in that the sprays of the spray nozzles (7) are arranged to collide with each other at least partly.

5. A spraying head according to claim 1, characterised in that the mist sprays of the spray nozzles (7) are when activated arranged to be combined into an at least mainly uniform mist spray.

6. A spraying head according to claim 1, characterised in that the frame-like body (2) comprises an outer body (2′) and an inner body (3) between which there is a channel space (4).

7. A spraying head according to claim 1, characterised in that the nozzles (7) are arranged in the body or into connection with it on the side of the channel (14).

8. A spraying head according to claim 1, characterised in that the nozzles (7) are arranged dividedly in the body (2) along a circle surrounding the channel (14).

9. A spraying head according to claim 1, characterised in that in the body (2) is arranged a pipe element (20) as an extension of the channel (14) which extends to a distance from the outlet opening of the channel (14) of the body.

10. A spraying head according to claim 1, characterised in that the spray nozzles (7) are arranged to spray into the channel (14) and/or the pipe element (20) being its extension.

11. A spraying head according to claim 1, characterised in that the spraying head (1) is arranged at a distance from an installation surface on the side of the channel (14).

12. A spraying head according to claim 1, characterised in that the pipe element (20) expands towards its outlet end.

13. A spraying head according to claim 1, characterised in that at least part of the sprays of the spray nozzles (7) are arranged to provide a rotational motion for the mist.

14. A spraying head according to claim 1, characterised in that at least part of the sprays of the spray nozzles (7) are directed to provide a rotational motion for the mist.

15. A spraying head according to claim 1, characterised in that at least part of the sprays of the spray nozzles (7) are arranged to provide a rotational motion for the mist in the channel (14) and/or in the pipe element (20) being its extension.

16. A fire-extinguishing apparatus, characterised in that the apparatus comprises at least one spraying head according to claim 1.

17. A method for extinguishing a fire, in which method medium mist is sprayed, characterised in that at least one spraying head according to claim 1 is used.
